(19) United States
(12) Patent Application Publication
(10) Pub. No.: US 2012/0180309 A1
(43) Pub. Date: Jul. 19, 2012

(54) Lithium Primary Cells

(75) Inventors: Fred J. Berkowitz, New Milford, CT (US); Nikolai N. Issaev, Woodbridge, CT (US); Jaroslav Janik, Southbury, CT (US); Zhiping Jiang, Westford, MA (US); Eric Navok, Stamford, CT (US); Bhupendra K. Patel, Danbury, CT (US); Michael Pozin, Brookfield, CT (US); Michael D. Sliger, New Milford, CT (US)

(73) Assignee: The Gillette Company, a Delaware corporation

(21) Appl. No.: 13/410,349

(22) Filed: Mar. 2, 2012

Related U.S. Application Data
(62) Division of application No. 12/129,158, filed on May 29, 2008.

(51) Int. Cl. H01M 6/10

(52) U.S. Cl. 29/623.5

(57) ABSTRACT

Primary lithium cells are provided, the cells having an anode comprising lithium and a cathode comprising iron disulfide. Features of the cells are optimized in order to enhance the cell performance within the constraints imposed by the maximum permitted level of lithium and standard cell dimensions.

### CROSS-REFERENCE TO RELATED APPLICATIONS

This application is a continuation-in-part of, and claims priority under 35 U.S.C. §120 to, U.S. patent application Ser. No. 12/129,158, filed on May 29, 2008 and entitled “Lithium Primary Cells”, which is incorporated herein by reference in its entirety.

### TECHNICAL FIELD

The invention relates to lithium primary cells having an anode comprising lithium and a cathode comprising iron disulfide (FeS₂).

### BACKGROUND

Primary (non-rechargeable) electrochemical cells having an anode of lithium are known and are in widespread commercial use. The anode is comprised essentially of lithium metal. One type of primary lithium cell has a cathode comprising iron disulfide (FeS₂), also known as pyrite. Such cells are designated Li/FeS₂ cells. Lithium cells also include an electrolyte comprising a lithium salt such as lithium trifluoromethane sulfonate (LiCF₃SO₃) dissolved in an organic solvent. These cells are referenced in the art as primary lithium cells and are generally not intended to be rechargeable. These cells are typically in the form of cylindrical cells, typically AA size or AAA size cells, but may be in other size cylindrical cells. Li/FeS₂ cells generally have a voltage (fresh) of between about 1.2 and 1.8 volts which is about the same as a conventional Zn/MnO₂ alkaline cell. However, the energy density (watt-hrs per cm³ of cell volume) of the Li/FeS₂ cell is higher than a comparable size Zn/MnO₂ alkaline cell.

Overall the Li/FeS₂ cell is much more powerful than the same size Zn/MnO₂ alkaline cell. That is, for a given continuous current drain, particularly at higher current drain over 200 mAmp, the voltage is flatter for longer periods for the Li/FeS₂ cell than the Zn/MnO₂ alkaline cell as may be evident in a voltage vs. time discharge profile. As a result, a higher energy output is obtainable from a Li/FeS₂ cell compared to that obtainable from the same size alkaline cell.

Thus, the Li/FeS₂ cell has the advantage over same size alkaline cells, for example, AAA, AA, C or D size or any other size cell in that the Li/FeS₂ cell may be used interchangeably with the conventional Zn/MnO₂ alkaline cell and will have greater service life, particularly for higher power demands. Similarly, the Li/FeS₂ cell can be used as a replacement for the same size rechargeable nickel metal hydride cell, which has about the same voltage (fresh) as the Li/FeS₂ cell. Thus, primary Li/FeS₂ cells can be used to power digital cameras, which require operation at high pulsed power demands.

The cathode material for the Li/FeS₂ cell may be initially prepared in a form such as a slurry mixture (cathode slurry), which can be readily coated onto the metal substrate by conventional coating methods. The electrolyte added to the cell must be a suitable organic electrolyte for the Li/FeS₂ system allowing the necessary electrochemical reactions to occur efficiently over the range of high power output desired. The electrolyte must exhibit good ionic conductivity and also be sufficiently stable and not produce undesirable reactions with the undischarged electrode materials (anode and cathode components) and also be non-reactive with the discharge products. Additionally, the electrolyte should enable good ionic mobility and transport of the lithium ion (Li+) from anode to cathode so that it can engage in the necessary reduction reaction resulting in Li₂S product in the cathode.

The cathode is generally prepared in the form of a slurry which contains solids which include FeS₂ active material, conductive carbon particles, and binder. Solvents are added to dissolve the binder and provide good dispersion and mixing of the solid components in the slurry. The cathode slurry is coated onto one or both sides of a thin conductive substrate, and then dried to evaporate the solvents and leave a dry cathode coating on one or both sides of the substrate, forming a cathode composite sheet.

A cell electrode assembly is formed with a sheet of lithium, the cathode composite sheet containing the FeS₂ active material, and a separator therebetween. The electrode assembly may be spirally wound and inserted into the cell casing, for example, as shown in U.S. Pat. No. 4,707,421. A representative cathode coating mixture for the Li/FeS₂ cell is described in U.S. Pat. No. 6,849,360. A portion of the anode sheet (e.g., an anode tab) is typically electrically connected to the cell casing which forms the cell's negative terminal. The cell is closed with an end cap which is insulated from the casing. A cathode tab extending from the cathode composite sheet can be electrically connected to the end cap which forms the cell's positive terminal. The casing is typically crimped over the peripheral edge of the end cap to seal the casing's open end. The cell may be fitted internally with a PTC (positive thermal coefficient) device or the like to shut down the cell in case the cell is exposed to abusive conditions such as external short circuit discharge or overheating.

The electrolytes used in primary Li/FeS₂ cells are formed of a lithium salt dissolved in an organic solvent. Representative lithium salts which may be used in electrolytes for Li/FeS₂ primary cells are referenced in U.S. Pat. No. 5,290,414 and U.S. Pat. No. 6,849,360 B2 and include such salts as: Lithium trifluoromethane sulfonate, LiCF₃SO₃ (LiTFS); lithium bistrifluoromethylsulfonyl imide, Li(CF₃SO₂)₂N (LiTFSI); lithium iodide, LiI; lithium bromide, LiBr; lithium tetrafluoroborate, LiBF₄; lithium hexafluorophosphate, LiPF₆; lithium hexafluoroarsenate, LiAsF₆; Li(CF₃SO₂)₃C, and various mixtures. Generally, specific salts work best with specific electrolyte solvent mixtures. U.S. Pat. Nos. 6,218,054, 5,290,414, and 5,514,491 disclose formulations of electrolytes containing lithium iodide as a solute in the mixture of 1,3 Dioxolane and dimethoxyethane (DME). In these references, all disclosed electrolyte formulations contain significantly more DME than dioxolane.

### SUMMARY

In general, the invention features primary lithium cells and methods for making such cells.

In one aspect, the invention features a primary lithium cell, comprising: an anode comprising lithium; a cathode comprising iron disulfide; a separator disposed between the anode and cathode; and an electrolyte comprising a lithium salt, 1,3-dioxolane, a glycol diether, and water.

Some implementations include one or more of the following features. The glycol diether comprises DME. The weight ratio of 1,3-dioxolane to DME is in the range of 4:6 to 9:1. The concentration of water in the electrolyte is from about 50 ppm-1000 ppm, e.g, about 100 ppm-600 ppm or about 100 ppm-300 ppm. The electrolyte comprises a mixture of two or more salts, selected from the group consisting of: LiI, LiCl, LiBr LiClO₄, LiAsF₆, LiPF₆, LiTFS, LiTFSI, LiBOB. The electrolyte comprises LiI at a concentration of about 0.5-2.0 M/L in combination with LiTFS at a concentration of about 0.006-0.5 M/L. The electrolyte further comprises an additive selected from the group consisting of 3,5-dimethylisoxazole (DMI), pyridine, trimethyl pyrazole, dimethyl pyrazole, and dimethyl imidazole.

In some implementations, the cell has been pre-discharged and the anode comprises a lithium foil that stretches during manufacture of the cell. In some such cases, the anode may comprise lithium at a weight of about 1.0 g, e.g., about 0.9 g to 1.0 g, after stretching of the lithium foil and pre-discharge of the cell.

The cell may, in some cases, be balanced so as to have an anode/cathode ratio of less than 1, e.g., between 0.83 and 0.96 or between 0.87 and 0.91.

In another aspect, the invention features a primary lithium cell, comprising: a can, a cap assembly comprising a positive terminal, the cap assembly being sealed to the can; and a spirally wound electrode assembly, disposed within the can. The electrode assembly comprises an anode comprising lithium, a cathode comprising iron disulfide, and a separator disposed between the anode and cathode, and further comprises an anode tab, configured to establish electrical connection between the anode and the can, the anode tab being welded to the can, and a cathode tab, configured to establish electrical connection between the cathode and the positive terminal, the cathode tab being welded to the cap assembly.

Some implementations may include one or more of the following features, as well as any of the features discussed above. The cathode tab comprises a Z fold. The cell further comprises a metal weld disk, welded between the anode tab and the can to connect the anode tab to the can.

In yet another aspect, the invention features a method of manufacturing a primary lithium cell, comprising: inserting into a can a spirally wound electrode assembly, the electrode assembly comprising an anode comprising lithium, a cathode comprising iron disulfide, and a separator disposed between the anode and cathode; welding an anode tab, extending from the anode, to the can; and, welding a cathode tab, extending from the cathode, to a positive terminal of the battery.

Some implementations include one or more of the following features. Welding the cathode tab comprises welding the cathode tab to a cap assembly that comprises the positive terminal. The method further comprises welding the anode tab to a metal weld disk, and welding the metal weld disk to the can. The method further comprises forming a Z fold in the cathode tab. The method further comprises forming the can by drawing a metal sheet to form a can body, and nickel plating the can body.

In a further aspect, the invention features a primary lithium cell, comprising: an anode comprising lithium; a cathode comprising iron disulfide; a separator disposed between the anode and cathode; and a PTC device, the PTC device having an internal hole diameter of less than about 5 mm.

In some implementations, the PTC device has an internal hole diameter of less than about 2.00 mm. The cell may include any of the features discussed above.

In yet another aspect, the invention features a method of manufacturing a primary lithium cell, comprising: inserting into a can a spirally wound electrode assembly, the electrode assembly comprising an anode comprising lithium, a cathode comprising iron disulfide, and a separator disposed between the anode and cathode, the cathode and anode including a cathode tab and an anode tab, respectively; applying an insulating tape to at least a portion of each of the cathode and anode tabs; establishing electrical connection between the anode tab and the can; and establishing electrical connection between the cathode tab and a positive terminal of the battery.

In some cases, applying the insulating tape is performed before the electrode assembly is spirally wound. The tape may comprise a polypropylene film with a synthetic rubber polyisobutene adhesive. The cell may include any of the features discussed above.

The invention also features, in another aspect, a primary lithium cell, comprising: a can, a cap assembly comprising a positive terminal, sealed to the can, and, within the can, a spirally wound electrode assembly. The electrode assembly comprises an anode comprising lithium and comprising an anode tab electrically connected to the can, a cathode comprising iron disulfide and comprising a cathode tab electrically connected to the positive terminal, and a separator disposed between the anode and cathode. At least a portion of each of the cathode and anode tabs is covered with an insulating tape.

In some cases, the anode tab is welded to the can and the cathode tab is welded to the positive terminal. The cell may include any of the features discussed above.

In a further aspect, the invention features a primary lithium cell, comprising: a can, a cap assembly comprising a positive terminal, sealed to the can by a seal comprising an annealed polypropylene copolymer, and, within the can, a spirally wound electrode assembly, the electrode assembly comprising an anode comprising lithium and comprising an anode tab electrically connected to the can, a cathode comprising iron disulfide and comprising a cathode tab electrically connected to the positive terminal, and a separator disposed between the anode and cathode.

In some cases, the anode tab is welded to the can and the cathode tab is welded to the positive terminal. The cell may include any of the features discussed above.

In another aspect, the invention features a method of making a primary lithium cell, comprising: forming an electrode assembly comprising an anode comprising lithium, a cathode comprising iron disulfide, and a separator disposed between the anode and cathode; inserting the electrode assembly into a can; and adding to the cell an electrolyte comprising a lithium salt, 1,3-dioxolane, a glycol diether, and water.

The method, and the cell formed by the method, can include any of the features discussed above. Also, in some implementations, the method can include pre-discharging the cell to reduce the lithium content of the anode to a predetermined lithium content, and/or balancing the cell so that the cell has an anode/cathode ratio of less than 1.

All publications, patent applications, patents, and other references mentioned herein are incorporated by reference in their entirety.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic view of a cylindrical lithium primary cell according to one implementation.

FIG. 2 is a schematic view of an anode tab with a weld disk welded thereto.

FIG. 3 is a schematic cross-sectional view of a lithium primary cell.

FIG. 3A is an enlarged detail view of area A of FIG. 3.

### DETAILED DESCRIPTION

In the cells described herein, a number of features have been optimized, in order to achieve the overall goal of enhancing cell performance while maintaining cell safety. Government regulations limit the amount of lithium the cell can contain (currently the maximum is 1 gram), while standard cell sizes determine the external volume of the cell and thus impose limitations on the possible internal cell volume available. In order to optimize cell performance within these constraints, the cells disclosed herein have been designed to effectively utilize a high percentage of the cell actives (substantially all of the cell actives, in preferred implementations). The internal cell volume has been maximized, as has the proportion of active to inactive components.

### General Cell Construction

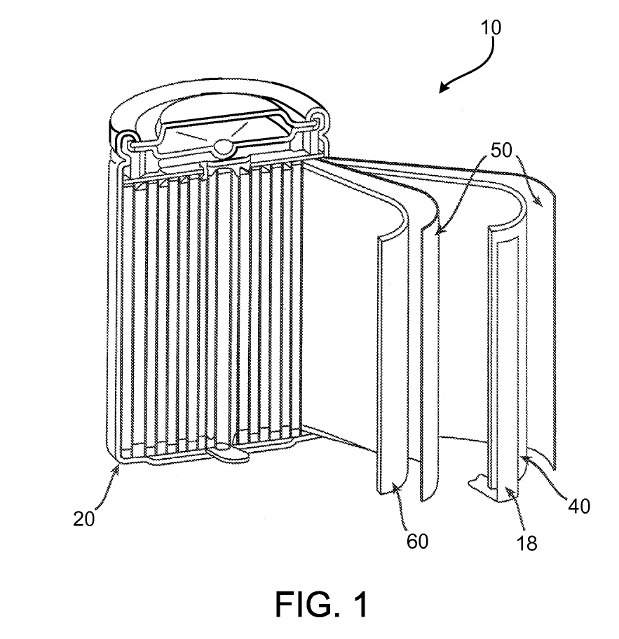

Referring to FIG. 1, the cell 10 includes a housing or “can” 20, an anode sheet 40 that comprises lithium metal, a separator 50, and a cathode sheet 60 that comprises iron disulfide (FeS₂). The cell also includes an electrolyte.

The cell may be of any size, for example, AAAA (40.2×8.4 mm), AAA (44.5×10.5 mm), AA (50×14 mm), C (49.2×25.5 mm) or D (60.5×33.2 mm) size. Cell 10 may also be a “⅔ A” cell (33.5×16.2 mm) or a CR2 cell (26.6×15.3 mm).

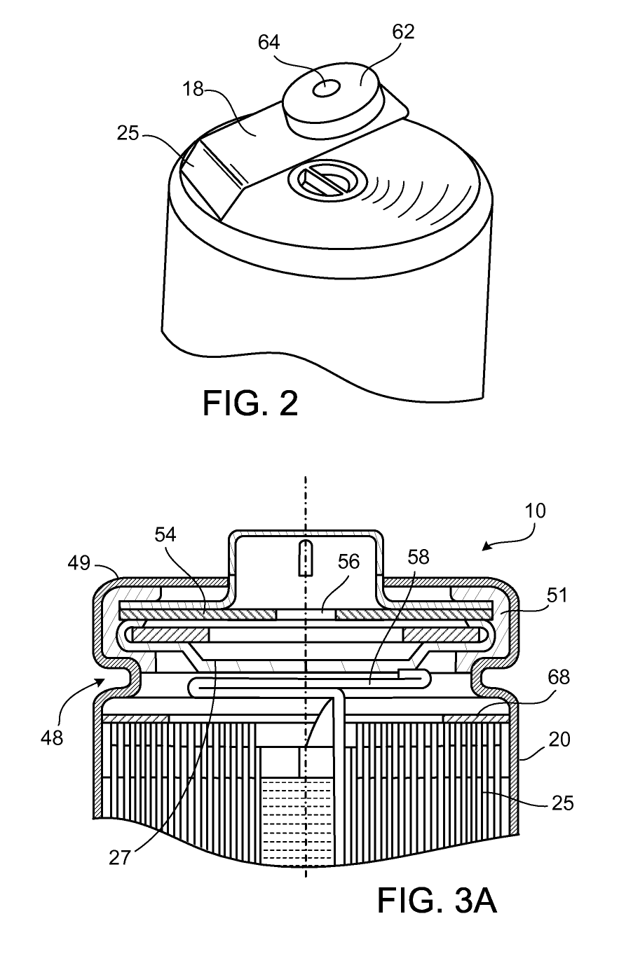

The cell may be cylindrical, or may be in the form of a spirally wound flat cell or prismatic cell, for example a rectangular cell having the overall shape of a cuboid. For a spirally wound cell, a preferred shape of the housing 20 is cylindrical, as shown in FIG. 1. The anode, cathode, and separator define a spiral wound electrode assembly 25 (FIG. 2), which can be prepared by spirally winding a flat electrode composite.

### Electrolyte

In some implementations, the electrolyte is formulated to optimize the solubility of the lithium salt in the solvent. Preferred electrolytes include lithium iodide, another lithium salt (e.g., LiTFS), a blend of 1,3 dioxolane and 1,2-dimethoxyethane (DME), and a small amount of water.

The solubility of lithium iodide is significantly higher in 1,3 Dioxolane than in DME. Balancing the amount of these two solvents allows the solubility of the lithium iodide to be optimized, thereby enhancing the conductivity of the electrolyte, especially at negative temperatures.

Moreover, in some cases DME exhibits reactivity with metal lithium. As a result, an excess of DME may have a negative effect on the cell, by inducing side reactions in the electrolyte when in contact with metal lithium.

Thus, preferred electrolytes for the cells disclosed herein use a combination of Dioxolane and DME. The weight ratio of Dioxolane to DME should generally be at least 2:3. The ratio is selected to increase solubility of the salt and to suppress possible reactivity of DME toward metal lithium. Preferred ratios of Dioxolane to DME by weight are generally in the range of 4:6 to 9:1.

Water should generally be present in the electrolyte in a concentration of about 50 ppm-1000 ppm to improve electrolyte conductivity. The electrolyte may include a mixture of two or more salts, which may be chosen, for example, from the following list: LiI, LiCl, LiBr LiClO₄, LiAsF₆, LiPF₆, LiTFS, LiTFSI, LiBOB. Preferred combinations include LiI at a concentration of about 0.5-2.0 M/L in combination with LiTFS at a concentration of about 0.006-0.5 M/L.

In addition to the mixture of DME, Dioxolane, and water, an additive of 3,5-dimethylisoxazole (DMI) (0.1%-1% by weight) can optionally be included to suppress possible polymerization of dioxolane. Alternatives to DMI include pyridine, trimethyl pyrazole, dimethyl pyrazole, or dimethyl imidazole. The range for concentration of LiI in this mixture of solvents is from about 0.5M to 2.0 M.

Other combination of ethers can also be used. For example 1,2 diethoxyethane (or other glymes (glycol diethers)) can be substituted for all or for a portion of the DME. Tetrahydrofuran (THF), or Me-THF, or similar derivatives of THF, can be used as a substitution of all or for a portion of the Dioxolane.

The electrolyte formulation may include, for example (percent of solvents in mixture is by weight):

0.8M LiI+0.006 M/L LiTFS in the following mixture of solvents: 70% Dioxolane, 30% DME, 0.2% DMI, and 150 ppm water.

As another example, the formulation may include:

0.8M LiI+0.006 M/L LiTFS in the following mixture of solvents: 45% Dioxolane, 55% DME, 0.2% DMI, and 150 ppm water.

Other suitable electrolytes may be used. For example, the electrolyte may comprise a mixture of dioxolane and sulfolane in a 8:2 volume ratio, 0.8 M LiTFSI salt, 600-1000 ppm pyridine, and 100-300 ppm water.

Preferably, an AA cell includes at least 1.7 cm³ of electrolyte.

### Cell Housing (Can)

The can is preferably formed from nickel plated cold rolled steel (CRS) with a wall thickness of about 0.15 mm to 0.40 mm, preferably from about 0.26 to 0.31 mm. The nickel can be preplated, and/or can be post-plated after the can is drawn.

Conventional cell cans are produced by drawing a steel sheet preliminarily applied with nickel-plating on both sides. The drawing process may in some cases cause cracks to form on the nickel-plated surface, exposing the iron base. This exposed iron base can potentially corrode, causing leakage, and can affect cell performance and the appearance of the product. Thus, it is generally preferred that the can material be post-plated after the can is drawn.

In some implementations, a steel plate (e.g., CRS) with no nickel-plating on either side is subjected to a drawing process, forming a cylindrical can with a bottom face. These cans are then electroplated, using a finishing nickel bath without a copper strike. The flash post-plating process typically adds 160 micro-inches (4 microns) of nickel plate to the CRS cans.

The nickel plating thickness need not be the same on the inside and outside surfaces of the can. The inside surface of a can is usually not subjected to abrasive forces and hence the plating does not need to be thick. The thickness of plating on the inside of the can only needs to be sufficiently thick to provide electrochemical stability with the cell chemistry. The outside surface of the can is subjected to more abrasive forces (e.g. during beading, crimping). Hence thicker nickel plating is generally required on the outside surface to prevent corrosion. Advantageously, this preferential plating tends to occur naturally during the process of plating drawn CRS cans. For example, when nickel-plating is applied on the outer surface in a 3 micron thickness, only about 0.4 to 0.5 micron thickness of nickel-plating is applied on the inner surface. Thus, this process is well suited for preferential nickel plating where thicker plating is desired on the outside surface of the can.

### Connection of Anode Tab to Can

As is generally the case in electrochemical cells, the anode is connected to the negative terminal of the external cell envelope, e.g., by connecting the anode to the can wall via an anode tab. This connection can be provided by a weld to the side of or to the bottom of the can, which has conventionally been formed by resistance welding from the inside of the can.

This resistance welding technique can be difficult to automate for large scale production. This type of weld involves insertion of a very small diameter (˜0.040″) copper weld rod down through the center core of the wound assembly, and using the rod to apply physical contact between the anode tab and the can surface. The weld rod tends to bind or catch the inner windings of the plastic separator material during insertion, and may bend and become permanently distorted.

The inventors have found that welding can be simplified by introducing a metal that forms an intermediate connection between the anode tab and cell can. This metal can be referred to as a weld disk. This weld disk can be easily spot welded externally to the wound assembly without having a weld rod inserted down through the wound assembly core. A second spot weld is used later to attach the weld disk to the cell can. In addition to simplifying the process, the use of a weld disk can reduce weld scrap and down time, help to ensure consistent cell performance, provide low impedance with lower variability, and provide a robust connection.

The weld disk material is compatible to the cell chemistry. The weld disk material may be, for example, 304L SS. The weld disk geometry can be a circular disc or square in shape. The thickness of the weld disk is preferably about 0.5 to 1.5 mm, e.g., about 1.0 mm. The anode tab 18 is spot welded to the weld disk 62 either by a resistance weld (RSW) or a laser beam weld (LBW) as shown in FIG. 2. The typical diameter of the spot weld 64 is about 0.50 mm (+/−0.10). The typical spot weld penetration is about 40 to 60% of the thickness of the thinner material. The wound assembly is then inserted in the open end of the can, with insulators at the top and bottom of the wound electrode assembly, as will be discussed below. The weld disk is welded to the can bottom, e.g., by laser beam.

Current Collection from Cathode to the Positive Terminal of the Battery

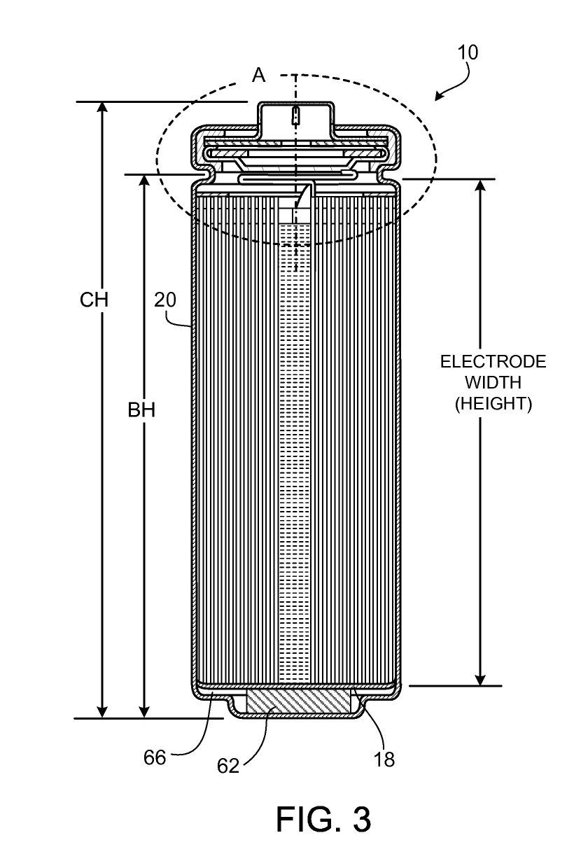

The cathode active is coated on a cathode substrate, e.g., aluminum foil or stainless steel, to form a cathode composite sheet as will be discussed in detail below. The cathode substrate will function as a current collector. A cathode tab 58 (FIG. 3A), which can be formed, for example, of Aluminum 1145, is then ultrasonically welded to the cathode substrate. The cathode tab is preferably about 52 to 56 mm long, 4.9 to 5.1 mm wide, and 0.05 to 0.15 mm thick, e.g., 0.09 to 0.11 mm thick. The thickness is selected to facilitate processing as well as enhance the current carrying capability of the product. Aluminum is preferred for its positive polarity and because aluminum is electrochemically stable at the potential encountered in use. The cathode tab is located at the lead edge of the cathode. However, one can design a cell with tab located anywhere along the cathode length. One advantage of having both negative and positive tabs at opposite ends is it provides uniform current distribution and hence uniform discharge along the entire electrode length.

During cell assembly, the cathode tab is connected to the positive terminal. The positive terminal consists of an assembly that includes multiple parts. One of the parts is a contact cup 27 (FIG. 3A). This part can be made, for example, of Aluminum 5052 H34, and generally includes a safety vent. The aluminum cathode tab is laser welded to this contact cup. The typical diameter of the fusion nugget (welded bond area) is about 0.4 to 0.5 mm (not including the heat-affected zone (HAZ)). Typical depth of weld penetration is about 40 to 60% of the thicker material of the two. Alternatively, the connection between the cathode tab and the contact cup can also be achieved by ultrasonic welding.

The dimensions (L×W×T) of the cathode tab may be, for example, 55×2.6×0.1 mm.

The typical chemical composition of Aluminum Alloy 1145 is shown in Table 1 below:

TABLE 1
Typical Chemical Composition

| Aluminum | Si & Fe | Cu | Mn | Mg | Zn | Ti |
|---|---|---|---|---|---|---|
| 99.45% Min | 0.55% | 0.05% | 0.05% | 0.05% | 0.05% | 0.03% |

Table II defines the preferred physical characteristics of the cathode tab:

| Ultimate Tensile | 22.7-23.5 | KSI |
|---|---|---|
| Strength (UTS) | | |
| Tensile Yield Strength | 21-21.3 | KSI |
| (YTS) | | |
| Elongation | 1.98-2.58% | |
| Camber | 1 mm in 1 meter | |
| Heat Treatment | Temper 19 | |
| Slit Width | 2.50/2.70 | mm |
| Thickness | 0.1 +/− 0.01 | mm |

### Electrode Assembly

The Li/FeS₂ cell is desirably in the form of a spirally wound cell comprising an anode sheet and a cathode composite sheet spirally wound with separator therebetween.

The cathode composite sheet may be formed of a cathode slurry comprising iron disulfide (FeS₂) cathode active material. (The term “slurry” as used herein will have its ordinary dictionary meaning and thus be understood to mean a dispersion and suspension of solid particles in liquid.) This slurry is coated onto at least one side of a substrate, preferably an electrically conductive substrate, such as aluminum foil or stainless steel. The cathode slurry is generally formed at ambient conditions, e.g., at about 22° C. The cathode slurry further includes conductive carbon particles (e.g., acetylene black and graphite), polymeric binder material, and solvent. The FeS₂ and carbon particles are bound to the substrate by the polymer, which may be for example an elastomeric block copolymer, preferably a styrene-ethylene/butylene-styrene (SEBS) block copolymer such as Kraton G1651 elastomer (Kraton Polymers, Houston, Tex.). This polymer is a film-former, and possesses good affinity and cohesive properties for the FeS₂ particles as well as for conductive carbon particle additives in the cathode mixture. The polymer resists chemical attack by the electrolyte.

The coated substrate forms a wet cathode composite sheet. The solvent is then evaporated, leaving a dry cathode coating mixture comprising the FeS₂ as well as conductive carbon particles and polymeric binder bound to each other and to the substrate. In some implementations, one side of the sheet is coated and dried, and then the other side is coated and dried. This forms the dry cathode composite sheet which may be subjected to calendering to compress the cathode coating on each side of the substrate.

On a dry basis, the cathode preferably contains no more than 4% by weight binder, and between 85 and 95% by weight of FeS₂. The coated cathode dimensions can be, for example, 284×41×0.179 mm. The width of the cathode is selected based on available height between the can bottom and the bead location. The cathode width can range between, e.g., 40.7 and 41.3 mm.

The cathode may be manufactured using a continuous coating process, in which segments, each having the dimensions of an individual cathode, are coated on the substrate and are separated by uncoated areas. These uncoated areas can be referred to as “mass free zones” (MFZ), and serve to allow the cathode tab to be welded to the substrate with high reliability. In some embodiments, the width of the MFZ is about 11 to 15 mm.

The anode is preferably a strip of pure lithium selected to be of suitable thickness for proper processing and performance requirements. The lithium foil is cold bonded to an electrically conductive tab along one end of the foil. The tab conducts current from the anode to the negative terminal of the cell. In other variations, the anode tab can be connected at any other location along the length. No substrate is used for the negative electrode to maintain electrical continuity, but can be included to maintain continuity as lithium discharges. This current collector can be of any metal that is electrochemically stable in the internal environment of the cell. The anode dimensions can be, for example, 308.50×0.1575×39 mm. The lithium width can range, for example, between 38.85 to 39.15 mm. The anode is preferably kept within the cathode width for better utilization of actives and safety. For this reason, the lithium (anode) width is usually smaller than the cathode width. For example, the lithium width can be about 2 mm smaller than the cathode width. In another variation, the lithium width can be as great as the cathode width for an improved surface area and hence the cell performance. The Nickel plated CRS tab (23.60×4.00×0.085 mm) is knurled in the area of contact with lithium. The knurled pattern improves the bonding of the tab to Lithium.

The anode and cathode tabs are partially covered with an insulating tape to prevent internal shorting of opposite polarity electrodes. In some implementations, this tape is polypropylene film with synthetic rubber polyisobutene adhesive (PPI 5011). The thickness of this tape can be, for example, 0.05 to 0.06 mm. The tape has the film backing of 0.03 mm thick polypropylene coated on one side with a 0.025 mm thick synthetic rubber adhesive.

Any tape material that is stable with the cell chemistry and has properties similar to those shown in the Table above can be used.

The anode assembly is laid between two pieces of separator material. The anode and cathode are preferably placed so that the leading edge of the cathode leads that of the anode by about 0 to 3 mm. The anode/separator assembly and the cathode assembly are then wound around a mandrel, preferably of 3.5 mm diameter, to form a wound electrode assembly such that the anode is electrically insulated from the cathode but is in close proximity to the cathode for efficient utilization of actives. This assembly is held in the wound state by applying a tape around it. This tape may be, for example, the same tape used to cover the anode and cathode tabs, except for having different dimensions. This tape can be of any size, for example a tape of 44 mm×20 mm can be used. In some embodiments, the tape can cover the full circumference and height of the wound electrode assembly.

### Cell Assembly

The wound assembly described above is inserted in the open end of the Nickel plated cold roll steel can, with insulators (described below) positioned at the top and bottom of the wound electrode assembly. As discussed above, the weld disk 62 is welded to the can bottom, e.g., by laser welding. The can is then beaded, forming a beaded area 48 (FIG. 3A). The beaded area limits movement of the wound electrode and provides a smooth seating surface for the cap assembly. The can wall thinning in the beaded area generally should not exceed 17% of the original wall thickness to preserve cell robustness and seal quality. Preferably, the bead depth and the adjacent radii are selected so as to provide a flat circumferential shelf of sufficient depth to provide good seal compression. The bead depth (measured on the outside of the cell) can be, for example, about 0.5 to 1.5 mm, e.g., about 1.15 to 1.35 mm. The upper bead radius can be, for example, about 0.3 to 1.0 mm, e.g., about 0.55 to 0.75 mm, and the middle bead radius can be, for example, about 0.10 to 0.70 mm, e.g., about 0.34 to 0.38 mm. These radii are also measured on the outside of the cell.

The cathode tab is then welded to the positive cap assembly, as discussed above, e.g., by laser weld or ultrasonic weld.

After an appropriate volume of electrolyte is added to the cell (e.g., 1.6 cc to 1.8 cc), the cap assembly is seated on the beaded assembly (resting on the upper portion of the bead) such that a ‘Z’ fold is formed in the cathode tab 58 above the wound electrode assembly 25 (see FIGS. 3 and 3A).

The edge 49 of the can 20 is then crimped around the cap assembly to seal the cap assembly to the can. A pre-crimping step may be performed, if desired. During pre-crimping, the upper edge of the can is bent towards the axis of the can, e.g., to 25 to 35 degrees from vertical. This bending centers the cap assembly with respect to the bead and can, and preloads the conductive components of the cap assembly against the cell components and compresses the Z fold in the cathode tab 58, thus ensuring good electrical contact between the assembled parts. This step, although optional, is generally preferred as it helps to ensure reliable cell crimping.

Next, the edge is fully crimped, to the position shown in FIG. 3A. After crimping, the bend in edge 49 has a radius of curvature R of, for example, about 0.90 to 1.25. A plastic seal 51 is provided between the can edge and the cap assembly. This seal deforms during crimping, filling voids between the can wall and the cap assembly and effectively sealing the cell's internal components from the outside environment. The compressed seal also generates sufficient pressure on the conductive cap assembly components, which in turn provides reliable electrical contact between these components, so that current can flow through to a device. By the same token, the seal also provides adequate electrical insulation between the negatively charged can and the positively charged cap assembly.

The seal 51 may be, for example, an injection molded part. A suitable material for the seal is polypropylene injection molding grade plastic, which is a high impact polypropylene copolymer resin. This material is commercially available, for example under the trade name Profax® SB 786 from Himont.

Before the seal is assembled into the cell it is preferably conditioned by the following annealing steps, which are performed at normal atmospheric pressure; (a) ramp temperature from 40° C. to 90° C. in 15 minutes; (b) hold at 90° C. for 2 hours; (c) ramp from 90° C. to 40° C. in 1 hour; and (d) for a minimum of 24 hours prior cell assembly, place seals into an environment where (air) dew point does not rise above −28° C. at normal atmospheric pressure (to stabilize moisture content in the material).

Generally, the seal compression rate (compressed thickness/original wall thickness*100%) is from about 25 to 70%, e.g., from about 35 to 45%.

The internal volume of the cell can be increased by minimizing the crimp height. In some preferred implementations the crimp height is less than 3.5 mm, e.g., about 3.25 mm.

### Cell Balancing

In some implementations the Li/FeS2 cell is desirably balanced so that the anode to cathode interfacial theoretical capacity ratio is less than 1.0, regardless of cell size. That is, the cell is balanced so that the anode theoretical capacity is less than the cathode theoretical capacity. Preferably the Li/FeS₂ cell is balanced so that the anode to cathode theoretical capacity ratio is between about 0.83 to 0.96, desirably between about 0.87 and 0.91, regardless of cell size. For example, the Li/FeS₂ cell size may be AA or AAA cylindrical size or smaller or larger sizes. The theoretical capacity of the anode and theoretical capacity of the cathode is based on those portions of anode and cathode with separator therebetween so that the anode and cathode portions are dischargeable. The cell balance of less than 1.0 is desirable to improve the cell efficiency (performance) at a high rate of discharge because the cathode active utilization at high discharge rates is less than 90%.

### Separator

Separators function as electrically insulating materials designed to allow ionic transport and to ensure safety by shutting down the current while remaining intact to prevent shorting. The separator occupies internal space without contributing to cell capacity, but is critical for safety and performance. Separator membranes need to incorporate three key items into their construction: reliability, energy performance, and safety shutdown performance. Excellent mechanical strength is required to assure effective electrode separation and reliable performance. Thermal integrity at high temperatures is essential if the cell is shorted, so that the separator can act as barrier for the ionic transport between electrodes. The membrane's porosity and permeability affects the ionic transport within the cell adding to overall total resistance.

The separator used in the cells described herein is preferably a microporous polypropylene film. Other suitable materials include polyolefins, such as polyethylene, polyethylene terephthalate, poly(vinylidene fluoride-co-hexafluoropropylene, poly(vinyl difluoride), poly(methyl methacrylate), polytriphenylamine, and multi-layer composites, copolymers, and blends of these and other polyolefins. The separator may include a surfactant coating, e.g., poly(ethylene oxide), poly(ethylene glycol dimethacrylate), Al₂O₃/SiO₂, or poly(vinyl acetate) to reduce electrical resistivity and increase ionic conductivity.

The length of the separator in the cell is determined by the length of the electrodes and the processing requirements of the winder. Typical separator length in an AA cell is 392 mm (each of two pieces). The separator may be relatively thin, e.g., less than about 0.04 mm, less than 0.03 mm, or even less than 0.020 mm. Preferred separator thicknesses are generally from about 0.012 mm to about 0.030 mm. The separator is preferably applied in excess relative to the size of both the anode and cathode to safely keep the cell from shorting. For example, two 44 mm wide membrane strips of material can be employed to completely isolate an anode that is 39 mm wide and a cathode that is 41 mm wide.

Some preferred cells include a separator formed of Celgard® 2400 membrane, a 25±3 μm thick monolayered microporous polypropylene based membrane. Preferred separator properties are listed in the table below:

| Separator Properties | | |
|---|---|---|
| Thickness (microns) | 25.4 ± 2.5 | |
| Basis Weight (mg/cm²) | 1.50 ± 1.5 | |
| MD Tensile Strength | 123 | MPa min |
| MD Elongation (%) | 50 | min |
| Tensile Strength TD | 11.7 | MPa min |
| Dimensional Change MD | 5 | max |
| Pore Width (microns) | 0.04 | max |
| Porosity (%) | 41 | average |

| | |
|---|---|
| Permeability (sec) | 25 ± 5 |

### Insulators

In the cells disclosed herein, the can is at negative potential. Two insulators are used to prevent the cathode (positive polarity) from contacting the can (negative polarity). The bottom insulator 66 (FIG. 3) includes a cut out designed to accommodate the anode tab during assembly. The bead insulator 68 (FIG. 3A) has an opening in the center. This design allows the cathode tab to be fed through the opening and also facilitates electrolyte introduction to the top of the wound electrode assembly. Each of these insulators is preferably about 0.25 to 0.30 mm thick, e.g., about 0.28 mm thick. The bottom and bead insulators may be of the same thickness or different thicknesses. The insulator material is chosen based on its chemical reactivity with the cell chemistry, its thermal stability at application temperatures, and ease of processability. A preferred material is polybutylterephthalate (PBT), for example DuPont Crastin® 6129C NC010 resin, containing 1-2% Clariant Remafin Black CEA 8019A color concentrate (50% Polyethylene 50% Carbon Black).

### Cathode Porosity

The active ingredients, and thus the cell performance, can be increased by minimizing electrode porosity as much as possible while allowing the cell to function properly at the intended application load. In the cells described herein, the volume of the anode is directly related to its dimensions because it has no porosity. The apparent volume of the cathode, however, is very dependent on the cathode porosity. For the same cathode mass, the volume can be very different if the porosities are different (volume will be higher for a high porosity cathode).

A cathode porosity of less than 25%, e.g., about 17 to 24%, for example about 22% has been found to be ideal for an AA cell. The cathode dimensions can be selected to target this porosity.

The cathode porosity is calculated as follows:

1. Weigh cathode sample and record weight in grams (W)

2. Measure cathode thickness and record the thickness in cm (ST). Deduct the thickness of the foil to obtain the coating thickness (CT) in cm.

3. Measure the coated area (CA) in cm²

4. Calculate % porosity as follows: (P)=(CA*CT−((W−(SA*R))/D))/(CA*CT)

Where:

R=Aluminum foil basis weight (for 20 micron foil use 0.0058 g/cm²)

D=density of cathode mix

SA=foil surface area

### PTC Device Configuration

The lithium cells generally include a positive thermal coefficient (PTC) safety device, as is well known in the battery field. A PTC device 54 is shown in FIG. 3A. Preferably, the PTC device includes an electrically conductive element which has the capability of changing its electrical resistance by several orders of magnitude when the device reaches a specified range of temperature. The PTC device includes a polymer that is filled or doped with a conductive material, for example polypropylene doped with carbon, formed into a thin sheet (e.g., about 0.36 mm nominal) and layered between two thin sheets (e.g., about 0.03 mm each) of Nickel or Nickel flash plated Copper foil.

The PTC device 54 includes a central, axially extending internal hole 56 to allow gas to escape in case of cell venting. Preferably, the internal hole diameter is less than 5 mm, e.g., less than 4 mm, less than 3 mm, or about 2.00 mm. Using a relatively small internal hole diameter increases the area of the PTC device and reduces the overall resistance of the PTC device without compromising safety. The reduction in the resistance contributed by the PTC device improves the cell performance. Preferably, the PTC has a resistance of about 9 to 20 milliohms, e.g., about 12 to 20 milliohms.

### Preferred Cell Dimensions

The relation of electrode height to cell height is illustrated in FIG. 3. In an AA cell, the maximum electrode width (height) used is 41.25 mm (41 mm typical). The height of the electrode is generally about 90 to 91% of the cell bead height (BH), and about 81 to 83% of the final cell height (CH). These dimensions are chosen for adequacy of internal fit, to allow room for sufficient electrolyte volume, and to allow sufficient space to accommodate the volume change during cell discharge.

Interfacial electrode height is defined here as the electrode height where the anode and cathode face each other. In some implementations, each centimeter of interfacial electrode height in the wound assembly has a void volume of 0.28 cc. In other words, each interfacial centimeter height of wound assembly will be able to accommodate 0.28 cc of electrolyte if filled completely. The void volume may range from about 0.25 to 0.30 cc.

The void volume number in the wound assembly (WA) is calculated as shown below:

Wound Assembly diameter=12.80 mm

Volume of 1 cm height of WA=3.14/4*(12.8/10)̂2*1=1.286 cc (a)

Volume of 1 cm height of cathode=0.4095 cc (b)

Volume of 1 cm height of anode=0.4880 cc (c)

Volume of 1 cm height of separator=0.1085 cc (d)

Void volume in 1 cm height of WA=(a)−(b)−(c)−(d)=0.28 cc

As discussed above, an Aluminum tab is used for the cathode and a nickel plated CRS tab is used for the anode. The preferred tab dimensions are determined at least in part based on the tab location in the cell and how sharp a radius it forms. Another factor that determines the tabs cross section dimensions (i.e. Width×Thickness) is the amount of load current the tab carries. The dimensions preferably minimize voltage drop as much as possible without affecting the performance in intended applications. The tab lengths are decided by cell assembly processing needs, and kept as small as possible. An example of suitable tab dimensions is shown below:

Cathode Tab:

Length: 55+/−0.5 mm

Width: 2.6+/−0.1 mm

Thickness: 0.10 mm typical

Cross-sectional area: 0.26 mm²

Anode Tab:

Length: 23.60+/−0.25 mm

Width: 4.0+/−0.1 mm

Thickness: 0.085 mm typical

Cross-sectional area: 0.34 mm²

### Pre-Discharge to Control Lithium Level

Present UN DOT regulations prevent cell manufacturers from having consumer cells with more than 1 gram of lithium. Therefore, the current practice among primary lithium cell manufacturers is to have commercial cells that do not exceed this limit. An anode having Length=308.5 mm, Width=39 mm, and Thickness=0.157 mm, results in a lithium volume of 1.8889 cm³. Using lithium density of 0.534 g/cc, the average lithium weight in such an anode is 1.0087 grams (1.0 gram to one significant digit).

The theoretical amount of lithium that would go into an anode having the above dimensions (assuming the lithium dimensions are maximum with respect to length, width, and thickness, and no stretching of lithium occurs during cell manufacturing processes) would be 1.07 grams. However, typical lithium stretching observed in our winding process is ˜5%. Considering this stretching, the actual lithium going into the cell is estimated at 1.019 grams.

The level of lithium can be reduced to the approved level by predischarging the finished cell before it is released for any purpose including testing. Typical OCV after electrolyte filling is ˜3.45V. Predischarge is done to bring the cell OCV near ˜1.8V. Keeping the cells at higher voltage can result in corrosion of the Aluminum substrate. Predischarge also seems to reduce any voltage delay issues. In the predischarge operation, a fixed amount of capacity is taken out of the cell within a few hours after activating the cell. The amount of this capacity is determined by internal actives amount in a given cell size. The amount of capacity withdrawn from the cell may be, for example, about 3 percent of the initial capacity of the cell. In some implementations, the capacity withdrawn from an AA cell may be, for example, about 0.131 Ah. This operation is done by discharging at about 1-4 Amp for about 2 to 20 seconds on, followed by 1-100 seconds of rest, for about 10 to 100 cycles. In some cases, the cell may be stored in between cycles at one or more stages, or after the cycles are completed, e.g., at elevated temperature. Based on lithium theoretical capacity of 3.862 Ah per gram of lithium, 0.131 Ah represents 0.034 grams of lithium discharged. That is, at the end of predischarge, the average amount of lithium left in an AA cell will be less than 1 gram.

### Other Embodiments

A number of embodiments of the invention have been described. Nevertheless, it will be understood that various modifications may be made without departing from the spirit and scope of the invention. For example, the cell need not include all of the features discussed above, and can include any desired combination of these features. Accordingly, other embodiments are within the scope of the following claims.

1. A method of making a primary lithium cell, comprising:
stretching a lithium foil and incorporating the stretched lithium foil into an anode;
assembling
the anode,
a cathode comprising iron disulfide,
a separator disposed between the anode and cathode, and
an electrolyte comprising a lithium salt, 1,3-dioxolane, a glycol diether, and water to form an assembled cell; and
pre-discharging the assembled cell;
wherein the anode comprises lithium at a weight of about 1.0 g after stretching of the lithium foil and pre-discharging of the cell.

2. The method of claim 1, wherein the glycol diether comprises 1,2-dimethoxyethane.

3. The method of claim 2 wherein the weight ratio of 1,3-dioxolane to 1,2-dimethoxyethane is in the range of 4:6 to 9:1.

4. The method of claim 1 wherein the concentration of water in the electrolyte is from 50 ppm-1000 ppm.

5. The method of claim 1 wherein the electrolyte comprises a mixture of two or more salts, selected from the group consisting of: LiI, LiCl, LiBr LiClO₄, LiAsF₆, LiPF₆, lithium trifluoromethane sulfonate, lithium bistrifluoromethylsulfonyl imide, lithium bis(oxalato)borate.

6. The method of claim 5 wherein the electrolyte comprises LiI at a concentration of 0.5-2.0 M/L in combination with lithium trifluoromethane sulfonate at a concentration of 0.006-0.5 M/L.

7. The method of claim 1 wherein the electrolyte further comprises an additive selected from the group consisting of 3,5-dimethylisoxazole (DMI), pyridine, trimethyl pyrazole, dimethyl pyrazole, and dimethyl imidazole.

8. (canceled)

9. The method of claim 1 wherein the anode comprises lithium at a weight of about 0.9 g to 1.0 g after stretching of the lithium foil and pre-discharge of the cell.

10. The method of claim 1 wherein the concentration of water in the electrolyte is from 100 ppm-600 ppm.

11. The method of claim 1 wherein the concentration of water in the electrolyte is from 100 ppm-300 ppm.

12. The method of claim 1 wherein the cell has an anode/cathode theoretical capacity ratio of less than 1.

13. The method of claim 12 wherein the anode/cathode theoretical capacity ratio is between 0.83 and 0.96.

14. The method of claim 13 wherein the anode/cathode theoretical capacity ratio is between 0.87 and 0.91.

15-37. (canceled)
